(19) United States
(12) Patent Application Publication
(10) Pub. No.: US 2013/0183080 A1
(43) Pub. Date: Jul. 18, 2013

(54) BALL JOINT

(71) Applicants: Frank Nachbar, Lemfoerde (DE); Volker Grube, Diepholz (DE); Cord Groneweg, Lemfoerde (DE); Tobias Hodde, Stemwede (DE)

(72) Inventors: Frank Nachbar, Lemfoerde (DE); Volker Grube, Diepholz (DE); Cord Groneweg, Lemfoerde (DE); Tobias Hodde, Stemwede (DE)

(73) Assignee: ZF FRIEDRICHSHAFEN AG, Friedrichshafen (DE)

(21) Appl. No.: 13/822,654

(22) PCT Filed: Aug. 25, 2011
(86) PCT No.: PCT/EP11/64590

§ 371 Date: Mar. 13, 2013

(30) Foreign Application Priority Data
Sep. 24, 2010 (DE) 10 2010 041 304.6

(51) Int. Cl. F16C 11/06

(52) U.S. Cl. CPC F16C 11/0685
USPC 403/122

(57) ABSTRACT

A ball joint with a ball stud (2) which has a spherical bearing area (3), which with the bearing area (3) is fitted and can move by sliding within a ball socket (4). The ball socket (4) is arranged in an opening (5) of a holder (6) and, with a solid body (12), is formed by injection-molding a material, which solidifies, around the ball socket (4) and the holder (6). The ball stud (2) projects outward, in an axial direction (11), from the holder (6). An axial retainer for the ball stud (2), which axially engages with the ball socket (4) and is encapsulated by the injection-molded material, is provided in the solid body (12).

This application is a National Stage completion of PCT/EP2011/064590 filed Aug. 25, 2011, which claims priority from German patent application serial no. 10 2010 041 304.6 filed Sep. 24, 2010.

### FIELD OF THE INVENTION

The invention concerns a ball joint with a ball stud having a spherical bearing area, which with the bearing area is fitted and able to move by sliding in a ball socket and, with this, is arranged in an opening of a holder, and a solid body formed by injection molding a solidifiable material around the ball socket and the holder, from which the ball stud projects outward in an axial direction.

### BACKGROUND OF THE INVENTION

The structure and assembly of ball joints designed as radial joints are based on the positioning and joining together of individual components (ball stud, ball socket, housing, sealing bellows, etc.) in individual processes and production steps. The function and properties of the radial joint as a whole are determined by the respective tolerance characteristics of the individual components and are optimized by finishing processes (tempering, grinding, etc.) in order to meet the customers' requirements.

EP 0 927 310 B1 discloses a ball joint with a ball joint housing comprising a tubular wall portion, which extends substantially coaxially with the ball stud that projects outward and carries the ball, and which surrounds the ball a distance away from it, wherein, when the ball has been inserted, a housing material fills the empty space between the wall portion and the ball, surrounding the ball in such manner that the ball is mounted and able to move within the housing material by rotating in a hollow that surrounds the ball around more than its half-shell. The tubular wall portion consists of a tubular profile section with inward-facing and outward-facing anchoring elements, such that the cast-in or injection-molded housing material fills only the free space between the tubular profile section and the ball, extending through but not beyond the full length of the tubular portion so that the tubular portion form the whole of the radial outer wall of the ball joint housing. In addition, an intermediate bearing layer is interposed between the hollow and the ball.

When acted upon by large axial loads this ball joint has insufficient strength to resist being pulled apart.

### SUMMARY OF THE INVENTION

Starting from there, the purpose of the present invention is to provide a ball joint of the type described to begin with, which has relatively high pull-apart resistance.

The ball joint according to the invention, in particular for a motor vehicle, comprises a ball stud having a spherical bearing area, which with the bearing area is fitted and able to move by sliding in a ball socket and, with the latter, is arranged in an opening of a holder, and comprises also a solid body formed by injection-molding a solidifiable material around the ball socket and the holder, from which the ball stud projects outward in an axial direction, such that in the solid body axial retaining means for the ball stud that cover the ball socket axially and are encapsulated by the material are provided.

By virtue of the axial retaining means integrated in the solid body by injection molding so as to cover the ball socket, the resistance of the ball joint against being pulled apart is increased.

According to a first embodiment of the invention, the axial retaining means are formed by rim sections of the holder covering the ball socket axially, which are preferably arranged around a rim of the holder's opening that surrounds the ball socket. Preferably, the rim sections extend alternately in opposite directions. In particular, the rim sections are inclined relative to the axial direction so that, preferably, they cover the ball socket with their free ends. Yet, the rim sections preferably run substantially in the axial direction. The rim sections can be made as separate components and attached to the holder. However, they preferably form a material unit with the holder. In particular, the rim sections are bent away from the holder.

According to a second, alternative embodiment of the invention the axial retaining means are formed by a pot-shaped container, in which the ball stud with the ball socket is seated. In this case the ball stud extends out of the container, in particular through a container opening, preferably in the axial direction. Preferably, at least in parts the rim of the container around its opening is bent radially inward toward the ball stud so that the rim covers the ball socket axially.

Preferably, the container extends through the opening of the holder. In particular, the container is axially secured onto the holder by the solid body. Preferably, and in particular on the side of the holder facing away from the container's opening, the container has a circular, radial projection whose outer diameter is larger then the diameter of the holder's opening. In this way the container is additionally secured axially in the holder.

In a further development of the invention, the solid body has a fixing extension formed during the injection of the material, which has an annular groove onto which a sealing bellows can be or is fixed. Preferably, the sealing bellows extends as far as the ball stud, in particular as far as a shank section thereof.

The ball socket can be injection-molded onto the bearing area. However, the ball socket is preferably formed as a separate component, in particular one which is snap-fitted onto the bearing area.

Preferably, the ball stud and/or the holder are each made of metal, in particular steel. For example, the holder can be a sheet component. The ball socket consists in particular of plastic, preferably polyoxymethylene (POM). The container, when present, is preferably made of metal, in particular steel. The solidifiable material consists for example of plastic or metal. In particular the solidifiable material consists of zinc, aluminum, magnesium or a fiber-reinforced polyamide such as PA66 GF30.

The bearing area has a preferably spherical bearing surface, which is preferably in contact with a preferably hollow spherical surface of the ball socket. Connected to the bearing area the ball stud comprises in particular a shank section, which projects out of the ball socket, the solid body and the container if present.

The holder surrounds the bearing area, in particular up to the level of its equator, so that radial forces can be transmitted effectively between the ball stud and the holder. Preferably the holder has an annular section around its opening, which is preferably flat. Preferably, the holder is a chassis component or part thereof. For example, the chassis component can be a control arm or a wheel carrier.

In particular, the ball joint according to the invention is designed as a radial joint and preferably comprises a reduced number of components. In particular, the ball joint according to the invention can be made with fewer assembly processes. By joining the pre-assembled ball stud with its ball socket and housing by means of the injection-molding process (with plastic, zinc, aluminum, etc.) the ball joint is preferably made as a complete joint cartridge. The term “housing” is in particular understood to mean the holder or the assembly consisting of the holder and the container. Thereafter, the ball joint is completed by fitting the sealing system comprising the sealing bellows. To improve force transmission, the housing is in particular designed such that the ball socket and/or the assembly consisting of the ball stud and the ball socket is supported in both the axial and radial directions. The holding fixture for the sealing system is formed either by the housing, and/or wholly or partially by the injected material, preferably in the form of the fixing extension. Preferably the housing comprises the axial retaining means. Depending on the view adopted, the housing can also comprise the solid body.

The ball joint according to the invention can be used with current, radially loaded products or chassis components, for example as a flange joint, a control arm joint or an external joint. Its performance can be improved by additional elements (for example, the pull-out force can be increased). The performance in the axial and radial loading directions can be strengthened/increased, for example by incorporating the container.

In particular, the following advantages are obtained:
Fewer components
Fewer assembly processes
Good release torque to frictional torque ratio, thanks to the use of known systems (POM ball socket, grease) and optimized pre-loading.

### BRIEF DESCRIPTION OF THE DRAWINGS

Below, the invention is described with reference to preferred embodiments illustrated in the drawing, which shows:

FIG. 1: A partial perspective representation of the ball joint according to a first embodiment of the invention,

FIG. 2: A view of the ball joint shown in FIG. 1, but seen from above,

FIG. 3: Another perspective and partially cut-away representation of the ball joint of FIG. 1,

FIG. 4: A side view of a second embodiment of a ball joint according to the invention.

### DETAILED DESCRIPTION OF THE PREFERRED EMBODIMENTS

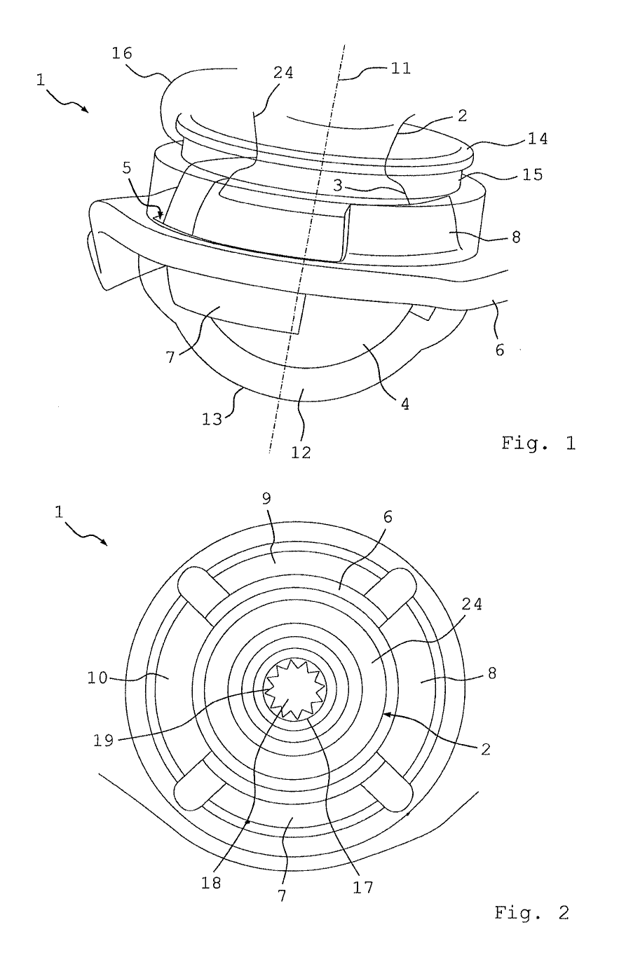

FIGS. 1 to 3 show various views of a first embodiment of a ball joint 1 according to the invention, which comprises a ball stud 2 with a spherical bearing area 3 also called the joint ball, which is fitted and able to move by sliding in a ball socket 4. The ball stud 2 fits and can rotate and swivel in the ball socket 4, which is arranged in a though-going opening 5 of a holder 6. The holder 6 surrounds the undeflected ball stud 2 up to the level of the equator of the joint ball 3, so that the holder 6 can take up radial forces applied to the ball stud 2. Bent away from the holder 6 are rim sections 7, 8, 9, 10 which extend at an inclination relative to the axial direction 11 and which cover the ball socket 4 axially with their free ends. In this case the rim sections are bent alternately in opposite directions so that, as shown, the rim sections 8 and 10 extend upward and the rim sections 7 and 9 extend downward. Before the assembly consisting of the ball socket 4 and the ball stud 2 is inserted into the opening 5, the rim sections or at least two of them opposite one another extend in the axial direction 11 and are only bent radially inward toward the ball stud 2 after the assembly has been inserted into the opening 5 in order to secure the assembly axially in the holder 6.

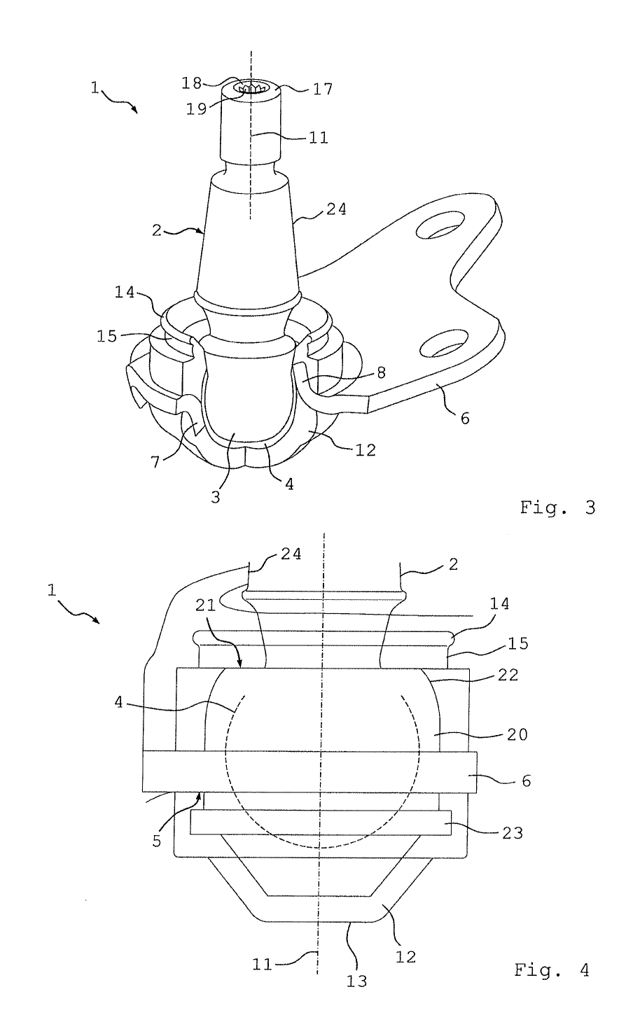

The assembly consisting of the ball stud 2, the ball socket 4 and the holder 6 now has injected around it a solidifiable material which, after it has solidified, forms a solid body 12 which is shown as transparent in FIG. 1 and can only be identified by its contour line 13. The solid body 12 has a fixing extension 14 with an annular groove 15, to which is attached a schematically represented sealing bellows 16 which extends as far as a shank area 24 of the ball stud 2. From FIG. 2 it can also be seen that at its free end 17, the ball stud 2 is provided with a recess 18 into which a key surface 19 can be inserted (in FIGS. 2 and 3 the sealing bellows is not shown).

FIG. 4 shows a side view of a ball joint 1 according to a second embodiment of the invention, wherein features similar or identical to the first embodiment are given the same indexes as in the first embodiment. The ball stud 2 is fitted and able to move by sliding in a ball socket 4, which is arranged in a pot-shaped container 20 having a container opening 21 through which the ball stud 2 extends outward from the container 20. The rim 22 of the container 20 that delimits the container's opening 21 is bent radially inward and therefore secures the assembly formed by the ball stud 2 and the ball socket 4 in the axial direction 11. The container 20 extends through a through-going opening 5 of a holder 6 and, on a side of the holder facing away from the container's opening 21, the container has a circular radial projection 23 whose outer diameter is larger than the diameter of the opening 5.

The assembly consisting of the ball stud 2, the ball socket 4, the container 20 and the holder 6 is encapsulated by injection-molding around it a solidifiable material, which when it has solidified, forms a solid body 12 represented as transparent in FIG. 4 and identifiable only by its contour line 13. The solid body 12 has a fixing extension 14 with an annular groove 15 to which a sealing bellows 16 that extends as far as a shank area 24 of the ball stud 2 can be attached.

### INDEXES

1 Ball joint

2 Ball stud

3 Bearing area of the ball stud/joint ball

4 Ball socket

5 Through-going opening in the holder

6 Holder

7 Rim section

8 Rim section

9 Rim section

10 Rim section

11 Axial direction of the ball joint

12 Solid body

13 Contour line of the solid body

14 Fixing extension

15 Annular groove

16 Sealing bellows

17 Free end of the ball stud

18 Recess

19 Key surface

20 Container

21 Opening of the container

22 Circular radial projection

24 Shank area of the ball stud

1-10. (canceled)

11. A ball joint with a ball stud (2) having a spherical bearing area (3), which with the bearing area (3) is fitted and slidably movable within a ball socket (4),
the ball socket (4) being arranged within an opening (5) of a holder (6),
a solid body (12) being formed by injection-molding a solidifiable material around the ball socket (4) and the holder (6),
the ball stud (2) projecting outward, in an axial direction (11), from the holder (6),
the solid body (12) comprising an axial retainer for the ball stud (2), which axially cover the ball socket (4) and being encapsulated by the injection-molded solidifiable material.

12. The ball joint according to claim 11, wherein the axial retainer is formed by rim sections (7, 8, 9, 10) of the holder (6) which axially engage with the ball socket (4).

13. The ball joint according to claim 12, wherein the rim sections (7, 8, 9, 10) alternately extend from the holder (6) in opposite axial directions.

14. The ball joint according to claim 12, wherein the rim sections (7, 8, 9, 10) are inclined relative to the axial direction (11) and free ends of the rim sections engage with the ball socket (4).

15. The ball joint according to claim 11, wherein the axial retainer is formed by a pot-shaped container (20) in which the ball stud (2) with the ball socket (4) is seated, and the ball stud (2) extends out of the pot-shaped container (20) through an opening (21) of the container.

16. The ball joint according to claim 15, wherein at least some areas of a rim (22) of the pot-shaped container (20), which delimits the opening (21) of the container, are bent inward toward the ball stud (2).

17. The ball joint according to claim 15, wherein the pot-shaped container (20) extends through the opening (5) of the holder (6).

18. The ball joint according to claim 17, wherein the pot-shaped container (20) has a circular, radial projection (23) which has an outer diameter that is larger than a diameter of the opening (5) of the holder (6).

19. The ball joint according to claim 11, wherein the solid body (12) has a fixing extension (14), formed when the solidifiable material is injected, which has an annular groove (15) onto which a sealing bellows (16) is attachable.

20. The ball joint according to claim 11, wherein the ball socket (4) is snapped onto the bearing area (3).

21. A ball joint comprising:
a ball stud having a spherical bearing area,
the bearing area being received within a ball socket which is arranged within an opening of a holder,
a solid body being formed by injection-molding a solidifiable material around the ball socket and the holder,
the ball stud projecting outward from the solid body along an axis,
the holder comprising rims which project radially into the opening of the holder, each of the rims having a first side and a second side which respectively correspond to a first surface and a second surface of the holder, the rims being alternately arranged, in opposite directions, along the axis such that the rims alternately extend in axially opposite directions and the first side of a first portion the rims and the second side of a remaining portion of the rims mate with the ball socket and restrict axial movement of the ball socket and the ball stud, and
the solid body axially covers the ball socket and encases the rims of the holder.
